(19) United States
(12) Patent Application Publication
(10) Pub. No.: US 2007/0221140 A1
(43) Pub. Date: Sep. 27, 2007

(54) Pet collar having a digital pet information storage and retrieval device

(75) Inventors: Jonathan Warren, West Palm Beach, FL (US); Julianne Sudman, Knoxville, TN (US); E. Douglas Grindstaff, Knoxville, TX (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/386,281

(22) Filed: Mar. 22, 2006

(51) Int. Cl. A62B 35/00

(52) U.S. Cl. 119/859

(57) ABSTRACT

A pet collar having a digital pet information storage and retrieval device for the identification of a pet is provided. The pet collar carries a modular ID device which is connectable to a computer via a conventional connection device. The ID device is provided for storing information data relative to the pet, including but not limited to identification information, owner information, health records, and the like. The ID device is removably received within an ID device housing secured to the pet collar. When a lost pet wearing the pet collar and ID device of the present invention is found, the finder removes the ID device and connects it to a standard computer and retrieves the data stored thereon in order to contact the owner and ensure proper care is taken of the animal until returned to its owner.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

The present invention pertains to the field of pet collars. More particularly, this invention relates to a pet collar having a removable data storage device carried thereon for storing information specific to the pet, such information including but not limited to owner identification, medical information, and the like.

2. Description of the Related Art

In the field of pet identification devices, it is well know that pet collars have been used for carrying information related to a pet. Typically, static devices have been used to carry information such as the name of the pet and the name and address of the owner. In many jurisdictions, tags are required for confirmation that the pet has been immunized from rabies and other communicable diseases. It is known that conventional static tags are limited in the amount of information that may be conveyed. Further, such tags are subject to degradation over time, whereby imprinted data eventually wears off at least to an extent that the information becomes indecipherable.

Dynamic tags have been provided to overcome some of the deficiencies of the static tags. For example, tags having battery powered displays for storing and displaying limited amounts of data have been provided. Further, tags have been provided to dial the owner's telephone number in the event the animal is found.

Identification markers have also been provided for storing owner information. The identification markers are configured such that they may be implanted in the animal and when scanned by a veterinarian with a dedicated detector, data stored on the marker is read and the owner identified. However, the number of animals that have been implanted, and the awareness of such device, is low enough that the finder of an animal does not always think to have a found animal scanned.

Devices having audio recording and playback capabilities have also been provided. However, as in other designs, the amount of information is limited to less than a minute of recorded data. Further, the quality of the audio recordings is less than acceptable in many applications. These, as well as the dynamic tags described above, are battery powered. Thus, they are functional only so long as the batteries are charged. When the batteries fail, in some devices the data is lost. In the remainder of the devices, the stored data may only be retrieved if the finder of the animal replaces the batteries.

Many devices have been developed to overcome these and similar problems associated with the identification of a lost pet via an animal carried device. Typical of the art are those devices disclosed in the following U.S. Patents and Patent Application Publications:

| Patent/App No. | Inventor(s) | Issue Date |
|---|---|---|
| 5,454,350 | S. M. Betheil | Oct. 3, 1995 |
| 5,752,335 | K. Shimogori et al. | May 19, 1998 |
| 5,877,742 | J. Klink | Mar. 2, 1999 |
| 5,955,953 | M. C. Hanson et al. | Sept. 21, 1999 |
| 6,003,473 | R. L. Printz | Dec. 21, 1999 |
| 6,067,018 | J. M. Skelton et al. | May 23, 2000 |
| 6,283,065 | J. E. Shorrock et al. | Sept. 4, 2001 |
| 6,502,060 | L. M. Christian | Dec. 31, 2002 |
| 6,568,354 | D. J. Wasserman et al. | May 27, 2003 |
| 6,721,681 | L. M. Christian et al. | Apr. 13, 2004 |
| 2002/0135487 | M. Bowling | Sept. 26, 2002 |
| 2003/0118979 | G. S. Axelrod | Jun. 26, 2003 |
| 2003/0229452 | B. S. Lewis et al. | Dec. 11, 2003 |
| 2005/0242137 | M. T. Fishman et al. | Nov. 3, 2005 |
| 2006/0011144 | L. Kates | Jan. 19, 2006 |
| 2006/0011145 | L. Kates | Jan. 19, 2006 |
| 2006/0011146 | L. Kates | Jan. 19, 2006 |

Of these patents, the '350 patent issued to Betheil discloses an electronic dialing attachment is adapted to be secured to a pet collar or other band member worn by a pet. The attachment includes a holder body having a channel for receiving a programmable dialing element. The dialing element is programmable to store a telephone dialing sequence corresponding to the telephone number of the owner of the pet and is detachably coupled to the holder body. If the pet is lost, the dialing element is adapted to be detached from the holder body and positioned near the handset of a telephone by the finder of the lost pet.

Shimogori et al., in the '335 patent, disclose a “talking” pet tag for association with a pet wherein a prerecorded message is easily retrievable by the finder of a lost pet by simply depressing a play button.

The '742 device disclosed by Klink is a medical identification bracelet which has electronic circuitry to display detailed, patient medical information. The bracelet is formatted using a programming station (into which is entered up to 16 k bits of medical and personal information about an individual. The programming station transfers the formatted information to the bracelet via an infra-red interface device. The medical identification bracelet has an LCD view screen which displays, in a scrolling fashion, data when a button is pushed. All information is available at the display.

In the '953 patent issued to Hanson et al., an article to be worn with an identification unit mounted thereon is disclosed. The identification unit includes a speaker for transmitting audio signals. Further included is a message playback switch for transmitting a playback signal and a message record switch for transmitting a record signal. The identification unit further includes a sound module adapted to store an audio message including a name of the pet and at least one of an address and a phone number upon the receipt of the record signal. The sound module further serves to playback the audio message upon the receipt of the playback signal.

In his '473 patent, Printz discloses a pet identification and retrieval device for providing information regarding a lost pet to an individual who finds the pet. The '473 device includes a front half enclosure and rear half enclosure. The front half enclosure contains a play switch, a speaker opening and a low battery indicator. The rear half enclosure contains a recessed recording switch, a permanent identification plate, and a fastening means. The device is connected to a pet's collar via a swivel link or is held stationary against the collar by other fastening means. A message is recorded using solid state digital recording and playback technology, which permits a 30-second message to be recorded.

The '018 patent issued to Skelton et al., discloses a lost pet notification system which includes three elements: a pet collar for automatically activating an alarm once the pet becomes lost; a portable hand held unit for continually monitoring the location of the pet; and a base station for automatically transmitting a signal to the owner once the portable unit determines that the pet is lost. When the pet moves too far away from the portable unit, the collar sounds an alarm, the portable unit communicates with the base unit, and a message is telephonically delivered to the pet owner that the pet is outside the range of the portable unit. When the pet moves back within range of the portable unit, the portable unit communicates with the base unit and a second message is telephonically delivered to the pet owner that the pet is once again within the range of the portable unit.

Shorrock et al., in their '065 patent, disclose a collar stud attachable to an animal collar to function as a tag, collar lock, and/or electronic identification device. The stud includes a cap positionable adjacent an exterior of the collar and a base that is positionable adjacent an interior surface of the collar. A linkage interconnects the cap and base in a spaced apart fashion to allow a portion of the collar to be sandwiched between the interconnected cap and base. At least a portion of the linkage extends through an aperture of the collar portion and helps secure the stud to the collar portion. In one embodiment, a transponder is incorporated into the stud, the transponder including a memory for storing an identification code. The code can be used to access a corresponding data record in a database.

The '060 patent issued to Christian discloses a chronometer for monitoring the age of a dog. The chronometer is further provided with identification information regarding the dog. The '060 device is attachable to a dog collar. Additional data, displays, and information may be carried, manipulated, entered and chosen by the use of user control buttons or the like.

Wasserman et al., in their '354 patent, disclose a pet identification tag with an electronic display for displaying pet owner identification information when activated. Pertinent information for the pet can be displayed. The pet identification tag is mountable on a dog or cat collar.

The '681 patent issued to Christian et al., discloses a chronometric identification and location tag for an animal, such as a dog, that incorporates a variety of detection and sensing functions as well as communication capacities. Assembled in a compact form that allows ready transport on a trainable animal, such as a dog, the chronometer identification and location tag enables the location of the associated animal, as well as the transmission and reception of information and data. Specific embodiments include the use of GPS to provide location data, as well as an alternative location system using temporary or permanent antenna installations. Hazardous material, visual, and acoustic detectors and other sensors and/or generators may be used in conjunction with transmission facilities for providing data regarding the animal's environment. Information and signals may be transmitted to the central controller by a receiver and a speaker can provide for audio signaling to the animal or others close to the animal in an audible range of the speaker.

Similar to the Printz device discussed above, the Bowling device disclosed in the '487 application is directed toward a portable, self-contained identification system including a base and a removable lid operatively and sealingly engageable with the base. The removable lid and the base cooperate to form a sealed enclosure when the removable lid is engaged with the base. A recording device includes a record microphone and a record switch and the playback device includes a speaker and a playback switch. The recording switch is manually actuated to record the message and a playback switch is actuated by the depression and the release of the playback button, such that the playback switch is automatically actuated by removal of the removable lid to playback the message.

Axelrod, in the '979 application, discloses a method and apparatus for providing textual, audio and/or video information regarding a pet to a user comprising supplying an electronic database which database has stored textual, audio and/or video information data files representative of the pet's behavior, identification, characteristics and the like. Although not illustrated, Axelrod teaches the use of a portable electronic device having a video display, an audio output, input controls and a database. Axelrod refers to the '979 device as electronic book specifically for educational purposes related to selecting, training and caring for animals.

Lewis et al., in their '452 application, disclose various systems and methods for integrating, managing and using electronic and tangible data relating to animals, especially data corresponding to official documentation. A secure, centralized repository for storing animal characteristic information, owner information, health information, official status information and the like is provided that may be used by a multiplicity of different user classes. Tangible counterparts of the electronic data also are provided, including documentation as well as fixtures that may be attached to an animal. A unique animal identification code is stored in the database and preferably appears on the tangible counterparts. The code serves as a primary key with respect to an animal's electronic records and allows records to be easily associated with a particular animal.

In their '137 application, Fishman et al., disclose an information case for protectively storing information related to an individual. The case includes a base having a cavity defined therein. The cavity is configured to store and protect an information-bearing medium on which the information related to the individual can be disposed. As disclosed by Fishman et al., the information is written or printed on the selected medium.

Kates, in his '144, '145 and '146 applications, discloses a computer-aided training and management system that uses a computer or other processor in wireless communication with an instrumented dog collar and/or optionally, one or more dog interaction devices. In one embodiment, the instrumented dog collar is in two-way communication with a central computer system.

### BRIEF SUMMARY OF THE INVENTION

The present invention is a pet collar having a digital pet information storage and retrieval device for the identification of a pet. The pet collar is provided for carrying a modular ID device which may be removed from the pet collar and connected to a computer via a conventional connection device. The ID device is provided for storing information data relative to the pet, including but not limited to identification information, owner information, health records, and the like.

The pet collar is fabricated from a flexible material adapted to be received about the neck of an animal and to receive an ID device housing adapted to receive the ID device. The ID device housing includes a base housing and top housing. A conventional fastening device is provided for securing the distal ends of the first and second collar members.

The base housing defines a receptor for removably receiving an ID device. In one embodiment, the base housing receptor defines a cylindrical threaded recess adapted to cooperatively receive an ID device having a similarly configured male threaded portion. To this extent, the ID device defines a top housing configured to cover the base housing receptor. A cylindrical wall is defined below the top housing. The exterior of the cylindrical wall defines a threaded portion to cooperate with the threaded recess defined by the base housing. A shoulder is defined under the top housing and about the cylindrical wall for engaging the top surface of the base housing. A seal is disposed between the shoulder and the base housing top surface, whereby as the cylindrical wall of the top housing is disposed within the threaded recess and then turned to secure the top housing on the base housing, the seal is likewise engaged.

A volume is defined within the top housing for receiving the ID device, which is a flash memory device. The ID device of the present invention is a USB flash drive configured specifically for the purposes of the present invention. The ID device includes a USB connector for mating with a standard USB port in a computer.

The ID device includes a housing for receiving the electrical components of the device. The housing defines a proximal end and a distal end. A USB connector extends from the housing distal end. The proximal end of the housing is configured to be hinged to an interior surface of the top housing cylindrical wall. When the top housing is removed from the base housing, the ID device is permitted to pivot from within the volume defined within the top housing. The distal end of the ID device, and specifically the USB connector, is thus withdrawn from within the top housing, thereby permitting connection to a computer.

In an alternate embodiment, the base housing defines a female receptor similar to that of a side release buckle. A male adapter module is provided for being received with the female receptor. A USB connecter cap is defined within a central extension member for receiving the ID device. The central extension member defines a recess configured to closely receive the housing of the ID device. The recess includes at least an end wall and side walls adapted to receive the ID device. The end wall defines a further recess configured to receive the USB connector extending from the ID device housing. The proximal end of the male adapter module defines an end wall configured to cover the distal end of the female receptor to limit movement of the male adapter module within the female receptor.

The ID device is used by a pet owner to store information relating to the pet wearing the device. Such information will typically include information regarding the identification of the owner, name of the animal, and the like. However, the ID device of the present invention is further useful for storing information such as the veterinarian responsible for medical treatments, updated records of immunizations, dietary needs of the animal, and any other pertinent information. Data is stored on the ID device in any format useful on a standard computer. For example, a pet owner may choose to store the above information in a spreadsheet. In this instance, the pet owner may insert links in the spreadsheet that will automatically connect the finder of the pet to the website of the veterinarian, thus giving the finder of the pet immediate access to a known caregiver. Maps to the owner's home or place of business, or to the pet's veterinarian may also be stored on the ID device. Using current internet technology, links to the maps may also be stored in order to ensure the most current maps are always available. Phone numbers may be provided for applications with auto-dialers. Pictures, videos, and audio files may also be stored on the device. A veterinarian may use the ID device each time the pet is seen. Specifically, whenever a vaccination is given or special medications or treatments are prescribed, the veterinarian may readily download such information onto the ID device. If the animal is subsequently lost and then found by a stranger, the finder will thus have immediate access to such information.

If a pet becomes lost, and then is found by a stranger, they will remove the top housing to reveal the ID device. The ID device is then plugged into a USB port on a standard computer. Most computers automatically recognize the presence of a USB device and will prompt the user as to what they want to do with the files on the device. The user can select to open the folder in order to view what files are available on the ID device.

The pet collar of the present invention may also be incorporated in a harness or other device configured to be worn by the pet. Further, while the present invention has been described as being worn on a pet, it will be understood by those skilled in the art that the present invention may also be adapted to be worn by a person.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a pet collar having a digital pet information storage and retrieval device constructed in accordance with several features of the present invention;

FIG. 2 is a side elevation view of the pet collar of FIG. 1;

FIG. 3 is a side elevation view of an alternate embodiment of the pet collar of FIG. 1;

FIG. 4 is an exploded view of the side release buckle used in one embodiment of the pet collar of FIG. 1;

FIG. 5 is an exploded perspective view of an ID device housing and ID device constructed in accordance with several features of the present invention;

FIG. 6 is an exploded perspective view of an alternate embodiment of the ID device housing and ID device of FIG. 5;

FIG. 7 is an exploded perspective view of a further alternate embodiment of the ID device housing and ID device of FIG. 5;

FIG. 8 is a perspective view of the anti-slip device incorporated in the pet collar illustrated in FIG. 1 in accordance with the present invention; and

FIG. 9 is a perspective view of an alternate embodiment of the present invention being worn by a pet and in wireless communication with a standard computer.

### DETAILED DESCRIPTION OF THE INVENTION

A pet collar having a digital pet information storage and retrieval device for the identification of a pet is disclosed. The pet collar is provided for carrying a modular digital pet information storage and retrieval device which may be removed from the pet collar and connected to a computer via a conventional connection device. The pet collar and digital pet information storage and retrieval device is illustrated generally at 10 in the figures. The digital pet information storage and retrieval device, or ID device, is illustrated at 12 in the figures. The ID device 12 is provided for storing information data relative to the pet, including but not limited to identification information, owner information, health records, and the like.

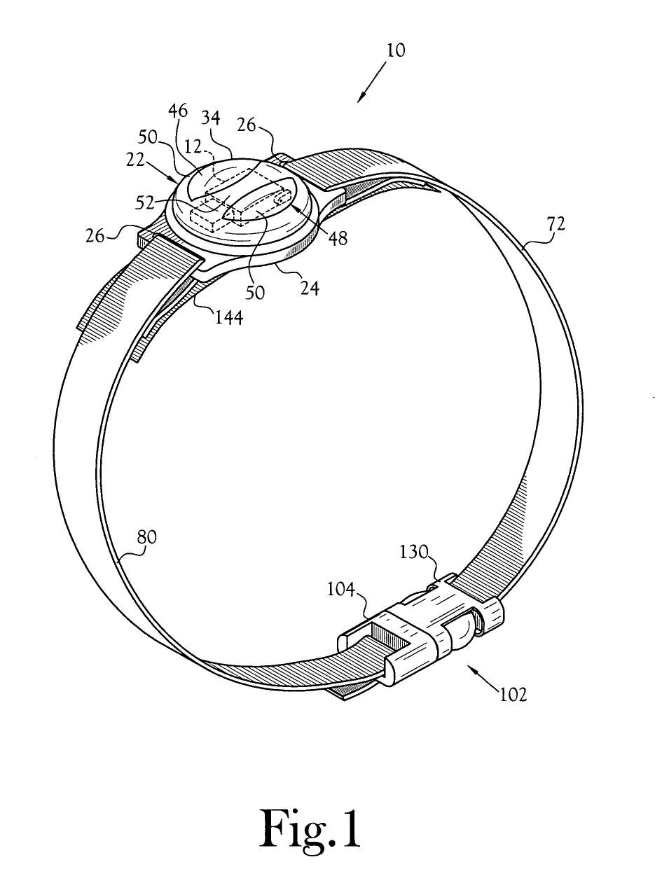

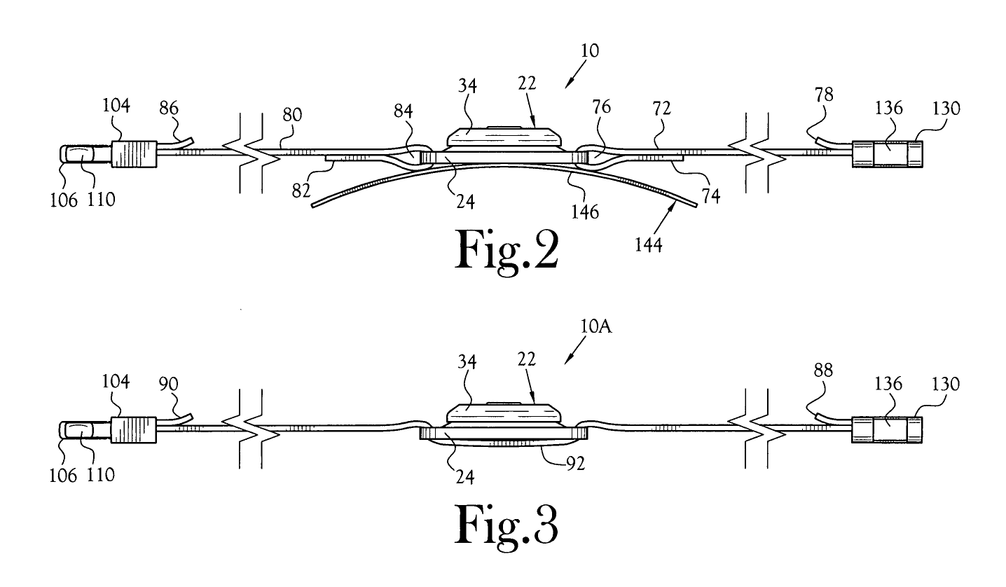

FIG. 1 illustrates the preferred embodiment of the present invention. The pet collar 10 of the illustrated embodiment is fabricated from a flexible material adapted to be received about the neck of an animal and to receive an ID device housing 22. The ID device housing 22 is provided and adapted for receiving the ID device 12 in a manner to maintain the integrity of the ID device 12 and the information stored therein. The ID device housing 22 of the illustrated embodiment includes a base housing 24 and top housing 34. As best illustrated in FIG. 2, the pet collar 10 defines a first collar portion 72, a second collar portion 80, and the base housing 24. The first collar portion 72 defines a proximal end 74 adapted to be secured to the base housing 24 and a free distal end 78. Similarly, the second collar portion 80 defines a proximal end 82 adapted to be secured to the base housing 24 and a free distal end 86. To this extent, the base housing 24 defines opposing slotted openings 26 configured to receive the proximal ends 74, 82 the first and second collar portions 72, 80. The proximal end 74 of the first collar portion 72 defines a loop 76 for receiving a portion of the base housing 24 after being received through one of the slotted openings 26. Similarly, the proximal end 82 of the first collar portion 80 defines a loop 84 for receiving a portion of the base housing 24 after being received through the other of the slotted openings 26. It will be understood that this configuration may be accomplished in various ways to make permanent either or both of the loop configurations 76, 84 of the first and second collar portions 72, 80 and the base housing slotted openings 26. Specifically, a loop 76, 84 may be formed by permanently stitching or otherwise fastening the proximal end 74, 82 of the respective collar portion 72, 80 onto the collar portion 72, 80 itself. Further, the slotted opening 26 may be integrally formed into the base housing 24, or may define a construction similar to a conventional wrist watch, with a pair of parallel extensions configured to removably receive a spring biased pin (not shown).

Further, in an alternate embodiment illustrated in FIG. 3, the pet collar 10A may be defined by a single elongated flexible member defining a first end 88, a second end 90, and a medial portion 92. One of the first and second ends 88, 90 is threaded through one of the slotted openings 26, under the base housing 24, and through the other of the slotted openings 26, with the base housing 24 ultimately disposed along the medial portion 92 of the pet collar 10A. In this embodiment, the loops 76, 84 are obviated and attachment of the base housing 24 to the pet collar is simplified. However, the potential for the base housing 24 to move along the pet collar 10A becomes a factor in determining placement of the pet collar 10A on the pet.

In either embodiment, the free ends of the pet collar are secured to each other to define a collar configuration. In the former embodiment, the distal ends 78, 86 of the first and second collar portions 72, 80 are secured to each other. In the latter embodiment, the first and second ends 88, 90 of the pet collar 10A are secured to each other. For ease of discussion, the former embodiment will be described from this point forward. A conventional fastening device 102 is provided for securing the distal ends 78, 86 of the first and second collar members 72, 80.

In the illustrated embodiment a side release buckle 102, illustrated most clearly in FIG. 4, is used to accomplish securement of the pet collar 10 around the neck of a pet. In this embodiment, the side release buckle 102 includes a male adaptor 104 configured to be cooperatively received within a female receptor 130. The male adaptor 104 defines at least a pair of opposed leaf spring members 106 biased away from each other. An outwardly extending tab 110 is defined by each of the leaf spring members 106. The outwardly extending tab 110 of the preferred embodiment defines a tapered leading edge 112 to assist the female receptor 130 in receiving the male adaptor 104. The outwardly extending tabs 110 define a shoulder 114 on the trailing edge to engage the female receptor 130 to prevent unselected disengagement of the side release buckle 102.

The female receptor 130 is configured to closely receive the male adaptor 104 when the opposed leaf spring members 106 are pressed together. To this extent, the distal end 132 of the female receptor 130 defines an opening 134 configured to receive the distal end 108 of the male adaptor 104 and engage the tapered leading edges 112 of the outwardly extending tabs 110. As the male adaptor 104 and female receptor 130 are engaged, an axial force on each causes the bias of the opposed leaf spring members 106 to be overcome, causing the opposed leaf spring members 106 to move toward each other to allow receipt of the male adaptor 104 within the female receptor 130. In order to maintain such engagement, the female receptor 130 defines opposed openings 136 configured to closely receive the outwardly extending tabs 110 defined by the opposed leaf spring members 106. Specifically, the shoulders 114 of the outwardly extending tabs 110 engages a distal portion 138 of the opposed openings 136 such that opposing axial forces applied to the first and second collar portion distal ends 78, 86 does not disengage the side release buckle 102.

The position of either or both of the male adaptor 104 and female receptor 130 is adjustable relative to the length of the first and second pet collar portions 72, 80. In the illustrated embodiment, the first pet collar portion 72 is permanently secured to the female receptor 130 through a slotted opening 142 defined by the proximal end 140 of the female receptor 130. The second pet collar portion 80 is adjustably secured to the proximal end 116 of the male adaptor 104. To this extent, the proximal end 116 of the male adaptor 104 defines a first slotted opening 118 and a second slotted opening 120, with the second slotted opening 120 disposed proximate the proximal end 116. A first lateral extension 122 defining a contoured top surface 124 is defined between the first and second slotted openings 118, 120. A second lateral extension 126 is defined between the second slotted opening 120 and the proximal end 116 of the male adaptor 104. The second lateral extension 126 defines a serrated interior face 128. The free distal end 86 of the second pet collar portion 80 is received through the first slotted opening 118 from the underneath, then passed over the contoured top surface 124 of the first lateral extension 122, and finally through the second slotted 120 opening from the top. The free distal end 86 of the second collar portion 80 is then pulled through the first and second slotted openings 118, 120 to achieve the desired overall length of the pet collar 10. The position of the second pet collar portion 80 with respect to the male adaptor 104 is maintained by engagement of the second pet collar portion 80 with the contoured top surface 124 of the first lateral extension 122 and the serrated interior face 128 of the second lateral extension 126.

Having described in detail a preferred fastening device 102, it will be understood that other configurations of the fastening device 102 described are within the scope of the present invention. Further, it will be understood that various other fastening devices 102 intended to accomplish the functions of the fastening device 102 described are likewise within the scope of the present invention.

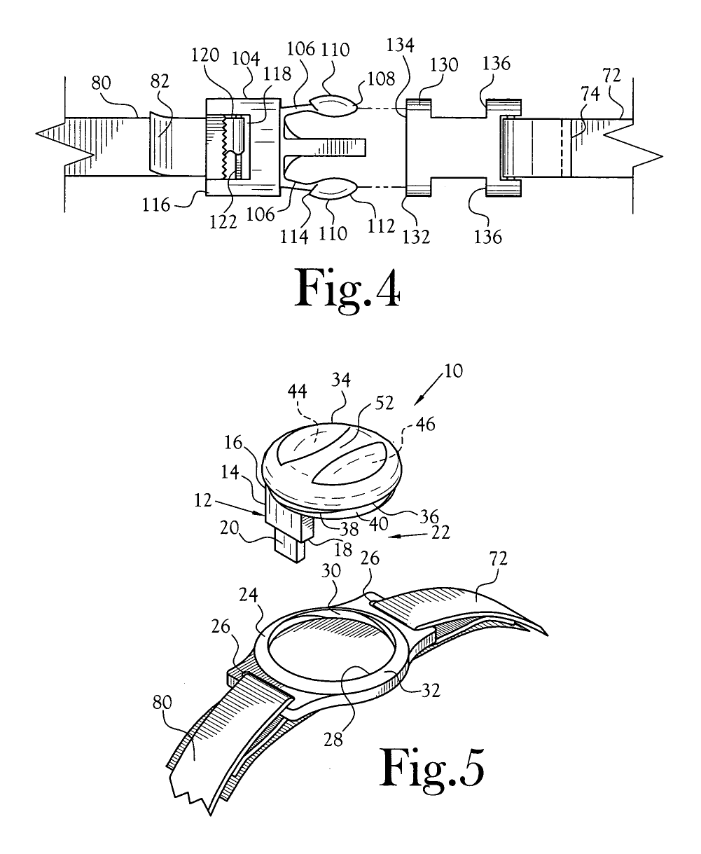

As illustrated in FIG. 5, the base housing 22 defines a receptor 28 for removably receiving an ID device 12. In the illustrated embodiment, the base housing receptor 28 defines a cylindrical threaded recess 30 adapted to cooperatively receive a top housing 34 having a similarly configured male threaded portion 38. To this extent, the ID device housing 22 includes a top housing 34 configured to cover the base housing receptor 28. A cylindrical wall 36 is carried on the underside of the top housing 34. The exterior of the cylindrical wall 36 defines a threaded portion 38 to cooperate with the threaded recess 30 defined by the base housing 24. A shoulder 40 is defined on the underside of the top housing 34 and about the cylindrical wall 36 for engaging the top surface 32 of the base housing 24. A seal 42 is disposed between the shoulder 40 and the base housing top surface 32, whereby as the cylindrical wall 36 of the top housing 34 is disposed within the threaded recess 30 and then turned to secure the top housing 34 on the base housing 24, the seal 42 is likewise engaged.

A volume 44 is defined within the top housing for receiving the ID device 12. In the preferred embodiment, the ID device 12 is a flash memory device. Flash memory is a form of electrically-erasable programmable read-only memory (EEPROM) which uses a rewritable memory chip that holds its content without the need of a power supply. Flash memory is a form of non-volatile read-write memory (NVRWM). Flash memory lends itself to applications such as the present in that it has good shock resistant characteristics. The ID device 12 of the present invention includes a universal serial bus (USB) connector 20 for connecting the ID device 12 via a standard USB port to a standard computer. Consequently, the ID device 12 of the present invention is a USB flash drive configured specifically for the purposes of the present invention. Currently, the memory capacity of conventional USB flash drives is up to 2 GB, which provides more than adequate storage capacity for storing the described information. With current technology, 2 GB of flash memory is capable of storing over 30 hours of audio, in excess of 12,000 pictures, several hours of video, or a combination of each. In light of the additional storage space and with anticipated advances in flash drive technology that promises larger storage capacities in the near future, it will be seen that many audio and or video files may be stored on the ID device 12 for different situations.

While a USB flash drive is illustrated and described, it will be understood by those skilled in the art that the present invention is adaptable to used with any other conventional flash drive configuration or similar EEPROM or other NVRWM device.

In the illustrated embodiment, the ID device 12 includes a housing 14 for receiving the electrical components (i.e., a circuit board and rewritable memory chip, not shown). The housing 14 defines a proximal end 16 and a distal end 18. The USB connector 20 extends from the housing distal end 18. The proximal end 16 of the housing 14 is configured to be hinged within the volume 44 defined within the top housing 34. When the top housing 34 is removed from the base housing 24, the ID device 12 is permitted to pivot from within the volume 44 defined within the top housing 34. The distal end 18 of the ID device 12, and specifically the USB connector 20, is thus withdrawn from within the top housing 34, thereby permitting connection to a computer. A USB connector cap (not shown) may be provided for receiving the USB connector 20 to further protect the integrity of the circuitry within the ID device 12. It is further envisioned that the USB connector cap may be hinged to the top housing 34 such that the ID device 12 is readily detachable from the top housing 34.

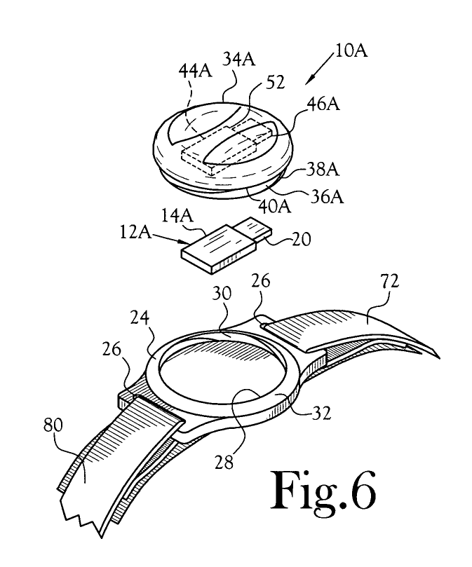

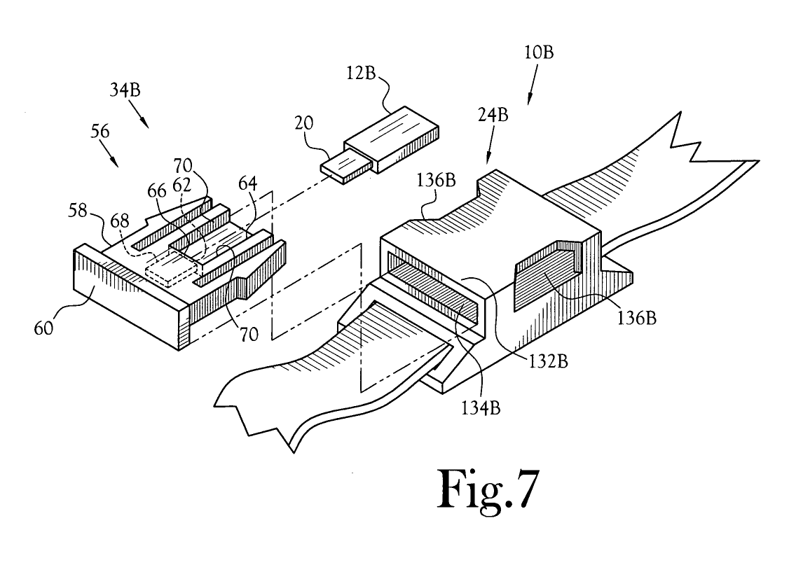

Alternatively, as illustrated in FIG. 6, the top housing 34A defines a static receptor 44A for fixedly receiving the ID device 12A, the ID device 12A being detachable from the top housing 34A. To this extent, the top housing 34A defines a receptor 44A configured to receive the entire profile of the ID device 12A.

In an alternate embodiment illustrated in FIG. 7, the base housing 24B defines a female receptor 44B similar to that described above for the side release buckle 102. A male adapter module 34B is provided for being received with the female receptor 44B. A USB connecter cap 62 is defined within a central extension member 56 for receiving the ID device 12B. The central extension member 56 defines a recess 64 configured to closely receive the housing 14B of the ID device 12B. The recess 64 includes at least an end wall 66 and side walls 70 adapted to receive the ID device 12B. The end wall 66 defines a further recess 68 configured to receive the USB connector 20 extending from the ID device housing 14B. The proximal end 58 of the male adapter module 34B defines an end wall 60 configured to cover the distal end of the female receptor 44B to limit movement of the male adapter module 34B within the female receptor 44B. Insertion and removal of the male adaptor module 34B is accomplished similarly to the connection and disconnection of the side release buckle 102 described above.

Referring back to FIG. 5, in the illustrated embodiment, at least a portion of the top housing 34 defines a translucent window 46 to readily view the ID device 12 stored therein. The translucent window 12 is also useful in visually inspecting the volume 44 defined in the top housing 34 without removing the top housing 34 from the base housing 24. Typically, a pet owner will perform such an inspection to ensure that the volume 44 has remained dry.

An engagement device 48 is provided for assisting in the securement and removal of the top housing 34 from the base housing 24. In the illustrated embodiment, the top housing 34 defines two recesses 50 configured to receive a user's thumb and index finger such that the top housing 34 may be manipulated either into or out of engagement with the base housing 24. However, it will be understood that other configurations of this engagement device 48, as well as other engagement devices 48, may be incorporated within the scope of the present invention.

An indicia plate 52 is disposed on the top housing 34 for receiving printed or engraved indicia. The indicia may be used for product branding, instructions for a finder of the pet, or the like.

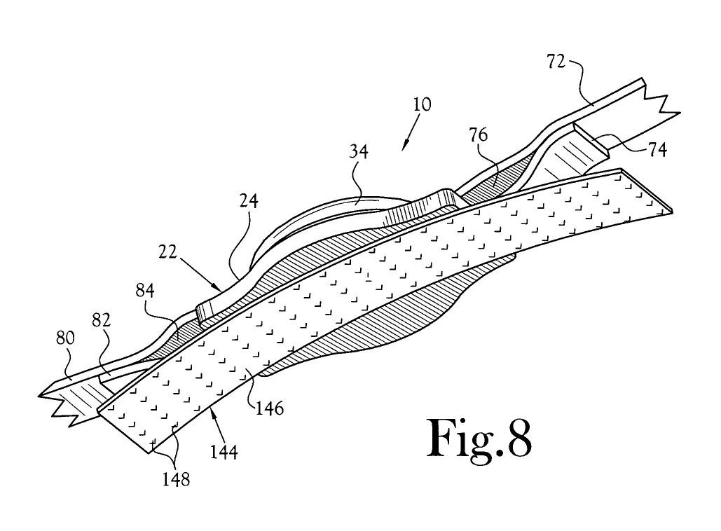

The ID device 12 housing is preferably carried on the top of the pet so that it is clearly visible to one who finds the animal. However, unless there is a counterweight (not shown) under the animal's neck to maintain the ID device housing 22 above the animal's neck, the tendency is for the ID device housing 22 to slide around and underneath the animal's neck. Accordingly, in the illustrated embodiment as best seen in FIGS. 2 and 8, an anti-slip device 144 is provided. The anti-slip device 144 of the present invention is an elongated member received under the ID device housing 22 and defining a bottom engagement surface 146. The bottom engagement surface 146 defines a plurality of barbs or cleats 148 that engage the fur of the animal in order to prevent slipping. The cleats 148 are configured such that the skin is not engaged. Accordingly, they do not create a risk of injury to the animal's skin.

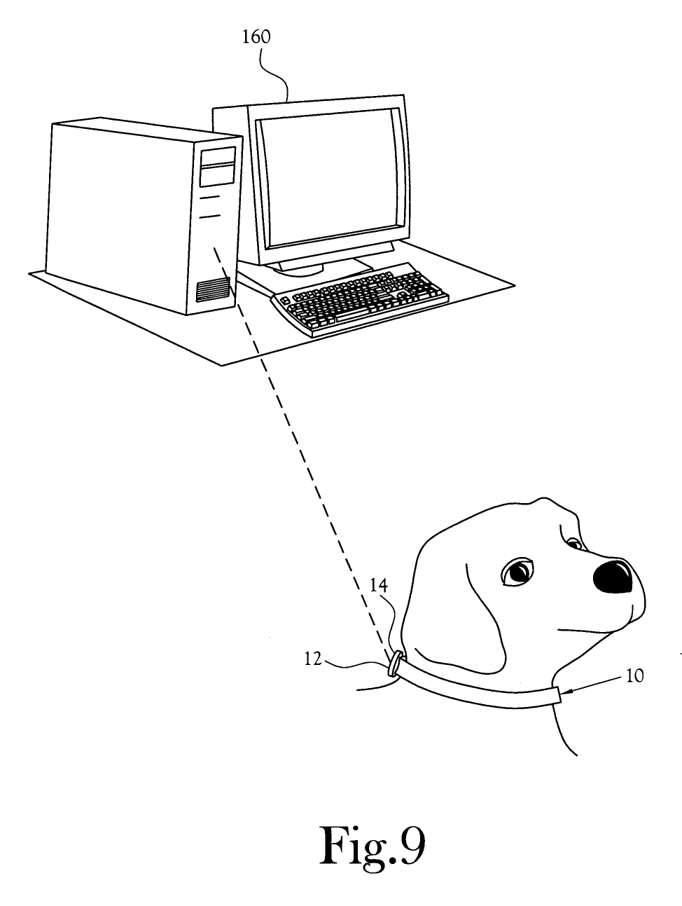

Further, it will be understood that other available technologies, and technologies yet to be developed, for storing and retrieving digital data may be used in accordance with the present invention. For example, as illustrated in FIG. 9, the ID device 12 is adapted to communicate via wireless connection using technology such as, but not limited to, Bluetooth® wireless technology, radio frequency technology, or infrared technology. In this embodiment where wireless technology is used, it will be understood that the ID device 12 may alternatively be adapted to be non-removable from the housing 14 and/or the pet collar 10. It will be recognized by those skilled in the art that this embodiment is especially useful in those situations where the pet becomes aggressive to the point that approaching the pet's neck to retrieve the ID device 12 is dangerous. However, the pet can be caged and then placed in close proximity to a standard computer 160 capable of communicating via the selected wireless technology such that the data is accessed without creating a harmful situation to either the pet or the handler.

The ID device 12 is used by a pet owner to store information relating to the pet wearing the device. Such information will typically include information regarding the identification of the owner, name of the animal, and the like. However, the ID device 12 of the present invention is further useful for storing information such as the veterinarian responsible for medical treatments, updated records of immunizations, dietary needs of the animal, and any other pertinent information. Data is stored on the ID device 12 in any format useful on a standard computer. For example, a pet owner may choose to store the above information in a spreadsheet. In this instance, the pet owner my insert links in the spreadsheet that will automatically connect the finder of the pet to the website of the veterinarian, thus giving the finder of the pet immediate access to a known caregiver. Maps to the owner's home or place of business, or to the pet's veterinarian may also be stored on the ID device 12. Using current internet technology, links to the maps may also be stored in order to ensure the most current maps are always available. Phone numbers may be provided for applications with auto-dialers. Pictures, videos, and audio files may also be stored on the device.

A veterinarian may use the ID device 12 each time the animal is seen. Specifically, whenever a vaccination is given or special medications or treatments are prescribed, the veterinarian may readily download such information onto the ID device 12. If the animal is subsequently lost and then found by a stranger, the finder will thus have immediate access to such information. For example, a dog being treated for heartworms may be required to remain in quiet, dark isolation in order to reduce the risk of heart failure. In such an instance, the finder will be alerted to this condition so that they will be able to continue this treatment to the best of their ability, thereby increasing the chance of survival of that dog.

If a pet becomes lost, and then is found by a stranger, they will remove the top housing 34 to reveal the ID device 12. The ID device 12 is then plugged into a USB port on a standard computer. Most computers automatically recognize the presence of a USB device and will prompt the user as to what they want to do with the files on the device. The user can select to open the folder in order to view what files are available on the ID device 12. In the embodiment wherein the ID device 12 is adapted to communicate wirelessly with the standard computer 160, the pet is placed in proximity with the computer 160 and data is retrieved via the selected wireless technology.

The pet collar 10 of the illustrated embodiment is a collar adapted to be worn around the neck of a pet. However, it will be understood by those skilled in the art that the inventive features of the present invention may also be incorporated in a harness or other device configured to be worn by the pet.

Further, while the present invention has been illustrated and described as being worn on a pet, it will be understood by those skilled in the art that the present invention may also be adapted to be worn by a person. For example, the present invention may be worn by a person who does not have the ability to communicate well, who may have tendencies to become disoriented, or who may have medical conditions such as epilepsy, Alzheimer's disease, or Downs Syndrome. In such instances, the memory device may include information regarding medications, treatments, physicians and other caregivers, as well as insurance information, consent to medical care in emergency situations, living wills, do not resuscitate orders, and the like.

From the foregoing description, it will be recognized by those skilled in the art that a pet collar having a digital pet information storage and retrieval device for the identification of a pet has been provided. The pet collar is provided for carrying a modular ID device which may be removed from the pet collar and connected to a computer via a conventional connection device. The ID device is provided for storing information data relative to the pet, including but not limited to identification information, owner information, health records, and the like.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A device carried by a subject such as an animal or person, said device for storing and updating digital information relative to the subject, said device comprising:
an apparatus adapted to be worn by the subject;
a housing carried by said apparatus; and
a memory device for storing and retrieving information relative to the subject, said memory device being carried within said housing, said memory device including at least one non-volatile read-write memory device received within a memory device housing, said memory device being adapted to be in selective communication with a standard computer.

2. The device of claim 1 wherein said memory device further including a standard connector for connecting said memory device to a standard computer for storing and retrieving digital information.

3. The device of claim 1 wherein said memory device is adapted to communicate with a standard computer via wireless technology.

4. The device of claim 3 wherein said memory device is an electrically-erasable programmable read-only memory (EEPROM) device.

5. The device of claim 4 wherein said EEPROM device is a flash memory device.

6. The device of claim 5 wherein said flash memory device includes a universal serial bus (USB) connector for connecting said flash memory device to a standard computer.

7. The device of claim 1 wherein said memory device is adapted to store data in the form of at least one of text data, video, audio and pictures.

8. The device of claim 1 wherein said housing includes a base housing and a top housing, said top housing defining a volume therein for receiving said memory device, said base housing and said top housing being selectively engaged to seal said volume.

9. The device of claim 8 wherein said base housing defines a receptor for removably receiving said top housing, said receptor defining a cylindrical threaded recess adapted to cooperatively receive a male threaded portion defined by said top housing, said top housing volume being defined within said male threaded portion.

10. The device of claim 9 wherein said memory device is hinged to said top housing within said volume.

11. The device of claim 9 wherein said volume is configured to closely and releasably receive said memory device.

12. The device of claim 9 wherein said top housing includes an engagement device for assisting in securing and removing said top housing from said base housing.

13. The device of claim 12 wherein said engagement device includes opposing recesses configured to receive a user's thumb and index finger to manipulate said top housing into and out of engagement with said base housing.

14. The device of claim 1 wherein said housing includes:
a base housing defining a receptor for releasably securing a top housing, said receptor defining a substantially rectangular recess defining an open first end, an opposed second end wall, opposing top and bottom walls, and opposing side walls, each of said opposing side walls defining a through opening; and
said top housing including:
an end wall;
an elongated central extension member extending orthogonally from said end wall, said elongated central extension member defining a receptor for receiving said memory device; and
a pair of opposing leaf spring members extending orthogonally from said end wall, said elongated central extension member being disposed between said pair of opposing leaf spring members, each of said pair of opposing leaf spring members defining an outwardly extending tab configured to be received within said through opening defined by said base housing receptor side walls, whereby said top housing is selectively engaged and disengaged from said base housing receptor by urging said pair of opposing leaf spring members toward each other and applying axial force in an appropriate direction.

15. The device of claim 1 wherein at least a portion of said housing defines a translucent window to readily view said memory device for visual inspection thereof.

16. The device of claim 1 further comprising an indicia plate disposed on said housing for receiving indicia.

17. The device of claim 1 wherein the subject is an animal and wherein said apparatus is a collar, said apparatus including an anti-slip device defining an elongated member having a bottom engagement surface defining a plurality of cleats for engaging the fur of the animal in order to prevent slipping of said device around the neck of the animal.

18. A device carried by a subject such as an animal or person, said device for storing and updating digital information relative to the subject, said device comprising:
an apparatus adapted to be worn by the subject;
a housing carried by said apparatus; and
a universal serial bus (USB) flash memory device for storing and retrieving information relative to the subject, said USB flash memory device being carried within said housing, said USB flash memory device including at least one non-volatile read-write memory device received within a memory device housing, and a USB connector for connecting said memory device to a standard computer for storing and retrieving digital information, said USB flash memory device being adapted to store data in the form of at least one of text data, video, audio and picture.

19. The device of claim 18 wherein said housing includes a base housing and a top housing, said top housing defining a volume therein for receiving said memory device, said base housing and said top housing being selectively engaged to seal said volume.

20. The device of claim 19 wherein said base housing defines a receptor for removably receiving said top housing, said receptor defining a cylindrical threaded recess adapted to cooperatively receive a male threaded portion defined by said top housing, said top housing volume being defined within said male threaded portion.

21. The device of claim 20 wherein said memory device is hinged to said top housing within said volume.

22. The device of claim 20 wherein said volume is configured to closely and releasably receive said memory device.

23. The device of claim 20 wherein said top housing includes an engagement device for assisting in securing and removing said top housing from said base housing.

24. The device of claim 23 wherein said engagement device includes opposing recesses configured to receive a user's thumb and index finger to manipulate said top housing into and out of engagement with said base housing.

25. The device of claim 18 wherein said housing includes:
a base housing defining a receptor for releasably securing a top housing, said receptor defining a substantially rectangular recess defining an open first end, an opposed second end wall, opposing top and bottom walls, and opposing side walls, each of said opposing side walls defining a through opening; and
said top housing including:
an end wall;
an elongated central extension member extending orthogonally from said end wall, said elongated central extension member defining a receptor for receiving said memory device; and
a pair of opposing leaf spring members extending orthogonally from said end wall, said elongated central extension member being disposed between said pair of opposing leaf spring members, each of said pair of opposing leaf spring members defining an outwardly extending tab configured to be received within said through opening defined by said base housing receptor side walls, whereby said top housing is selectively engaged and disengaged from said base housing receptor by urging said pair of opposing leaf spring members toward each other and applying axial force in an appropriate direction.

26. A device carried by a subject such as an animal or person, said device for storing and updating digital information relative to the subject, said device comprising:
an apparatus adapted to be worn by the subject;
a housing carried by said apparatus, said housing including a base housing and a top housing, said top housing defining a volume therein, said base housing and said top housing being selectively engaged to seal said volume, said base housing defining a receptor for removably receiving said top housing, said receptor defining a cylindrical threaded recess adapted to cooperatively receive a male threaded portion defined by said top housing, said top housing volume being defined within said male threaded portion, said top housing including an engagement device for assisting in securing and removing said top housing from said base housing; and
a universal serial bus (USB) flash memory device for storing and retrieving information relative to the subject, said USB flash memory device being carried within said housing volume, said USB flash memory device including at least one non-volatile read-write memory device received within a memory device housing, and a USB connector for connecting said memory device to a standard computer for storing and retrieving digital information, said USB flash memory device being adapted to store data in the form of at least one of text data, video, audio and picture.

27. The device of claim 26 wherein said memory device is hinged to said top housing within said volume.

28. The device of claim 26 wherein said volume is configured to closely and releasably receive said memory device.

29. The device of claim 26 wherein said engagement device includes opposing recesses configured to receive a user's thumb and index finger to manipulate said top housing into and out of engagement with said base housing.
